(19) United States
(12) Patent Application Publication
(10) Pub. No.: US 2012/0084359 A1
(43) Pub. Date: Apr. 5, 2012

(54) INFORMATION PROCESSING DEVICE, INFORMATION PROCESSING METHOD, AND COMPUTER READABLE RECORDING MEDIUM

(75) Inventor: Daiki MIZUTANI, Kuwana-shi (JP)

(73) Assignee: BROTHER KOGYO KABUSHIKI KAISHA, Nagoya-shi (JP)

(21) Appl. No.: 13/231,392

(22) Filed: Sep. 13, 2011

(30) Foreign Application Priority Data
Sep. 30, 2010 (JP) 2010-221002

(51) Int. Cl. G06F 15/16

(52) U.S. Cl. 709/204

(57) ABSTRACT

An information processing device in an information communication system in which node devices are connected to an overlay network, and contents are distributed in the node devices, includes: an acquisition unit acquiring domain information from an inquiry device; a retrieval unit retrieving the content corresponding to the indicted domain name; a transmission unit transmitting, to the inquiry device, location information of the node device that saves the content corresponding to the indicated domain name; a storage unit storing the location information; and a first determination unit determining whether the location information is stored in the storage unit or not. If the location information is stored in the storage unit, the transmission unit transmits the location information corresponding to the acquired domain information to the inquiry device. If the location information is not stored in the storage unit, the retrieval unit retrieves the content.

### CROSS-REFERENCE TO RELATED APPLICATION

This application is based upon and claims the benefit of priority of Japanese Patent Application No. 2010-221002 filed on Sep. 30, 2010, the contents of which are incorporated herein by reference in its entirety.

### BACKGROUND

The present disclosure relates to a technical field of a delivery system of a peer-to-peer (P2P) type having a plurality of node devices that can communicate with each other on a network.

In recent years, there has been known a distributed content saving system in which a content to be delivered to terminal devices is distributed and saved in a plurality of server devices, and the delivery load of the content is distributed in the plurality of server devices. In the distributed cache system, if a cache server A does not save a content requested from a client terminal, the cache server A transmits a request for the content to an origin server. When a cache control server receives the request for the content to the origin server from a cache server A, the cache control server transfers the content from a cache server B that saves the requested content to the cache server A under control.

### SUMMARY

It is assumed that a domain name system (DNS) is applied to a contents delivery network (CDN). In this case, when the DNS server receives a request for resolving a domain name from a device which is a client, the DNS server returns, for example, an internet protocol (IP) of a server device that saves the content to the device in correspondence with the received domain name.

However, when the number of server devices that each save the content corresponding to the domain name is small, if the number of requests for the content to a specific domain is larger, a load is concentrated on a specific server device. For that reason, the advantage of the CDN that the delivery load of the content is distributed cannot be sufficiently used.

An aspect of the disclosure has been made in view of the above circumstances, and therefore an object is to provide an information processing device, an information processing method, and an information processing program, which can distribute the delivery load of the content in a system applying the DNS to the CDN.

The aspect of the disclosure provides the following arrangements:

An information processing device in an information communication system in which a plurality of node devices are connected to a network to configure an overlay network, and contents are distributed and saved in the plurality of node devices, the information processing device comprising:

an acquisition unit configured to acquire domain information indicative of a domain name inquired by an inquiry device;

a retrieval unit configured to retrieve the content corresponding to the indicted domain name through the overlay network;

a transmission unit configured to transmit, to the inquiry device, location information indicative of a location of the node device that saves the content corresponding to the indicated domain name;

a storage unit configured to store the location information retrieved by the retrieval unit in association with the domain information; and

a first determination unit configured to determine whether the location information corresponding to the acquired domain information is stored in the storage unit or not,

wherein if the first determination unit determines that the location information is stored in the storage unit, the transmission unit transmits, to the inquiry device, the location information stored in the storage unit and corresponding to the acquired domain information, and

wherein if the first determination unit determines that the location information is not stored in the storage unit, the retrieval unit retrieves the content.

An information processing method in an information communication system in which a plurality of node devices are connected to a network to configure an overlay network, and contents are distributed and saved in the plurality of node devices, the information processing method comprising:

acquiring domain information indicative of a domain name inquired by an inquiry device;

determining whether location information indicative of a location of the node device that saves the content corresponding to the indicated domain name is stored in a storage unit or not;

if it is determined that the location information is stored in the storage unit, transmitting, to the inquiry device, the location information stored in the storage unit and corresponding to the acquired domain information; and

if it is determined that the location information is not stored in the storage unit,
retrieving the content corresponding to the indicted domain name through the overlay network;
transmitting, to the inquiry device, the location information indicative of the location of the node device that saves the retrieved content; and
storing the location information indicative of the location of the node device that saves the retrieved content in association with the domain information in the storage unit.

A computer readable recording medium, the recording medium storing an information processing program executable by a computer included in an information processing device in an information communication system in which a plurality of node devices are connected to a network to configure an overlay network, and contents are distributed and saved in the plurality of node devices, the information processing program causing the computer to execute:

acquiring domain information indicative of a domain name inquired by an inquiry device;

determining whether location information indicative of a location of the node device that saves the content corresponding to the indicated domain name is stored in a storage unit or not;

if it is determined that the location information is stored in the storage unit, transmitting, to the inquiry device, the location information stored in the storage unit and corresponding to the acquired domain information; and

if it is determined that the location information is not stored in the storage unit,
retrieving the content corresponding to the indicted domain name through the overlay network;
transmitting, to the inquiry device, the location information indicative of the location of the node device that saves the retrieved content; and
storing the location information indicative of the location of the node device that saves the retrieved content in association with the domain information in the storage unit.

### BRIEF DESCRIPTION OF THE DRAWINGS

FIG. 1 is a diagram illustrating an outline configuration example of a content delivery system S according to an embodiment.

FIG. 2 is a diagram illustrating an example of an operation outline of the content delivery system S according to the embodiment.

FIG. 3 is a diagram illustrating an example of an operation outline of the content delivery system S according to the embodiment.

FIG. 4 is a diagram illustrating an outline configuration example of a router.

FIG. 5 is a diagram illustrating an outline configuration example of a P2P DNS server.

FIGS. 6A and 6B are a flowchart illustrating a processing example of a control unit of a router according to the embodiment.

FIGS. 7A and 7B are a flowchart illustrating a processing example of a control unit of the P2P DNS server according to the embodiment.

FIG. 8A is a flowchart illustrating a processing example in content cache addition instruction processing of the control unit of the P2P DNS server according to the embodiment.

FIG. 8B is a flowchart illustrating a processing example in content holding node retrieval processing of the control unit of the P2P DNS server according to the embodiment.

### DESCRIPTION OF EXEMPLARY EMBODIMENTS

Hereinafter, an exemplary embodiment will be described with reference to the accompanying drawings. A content delivery system according to the embodiment will be described below.

### 1. Outline Configuration of Content Delivery System

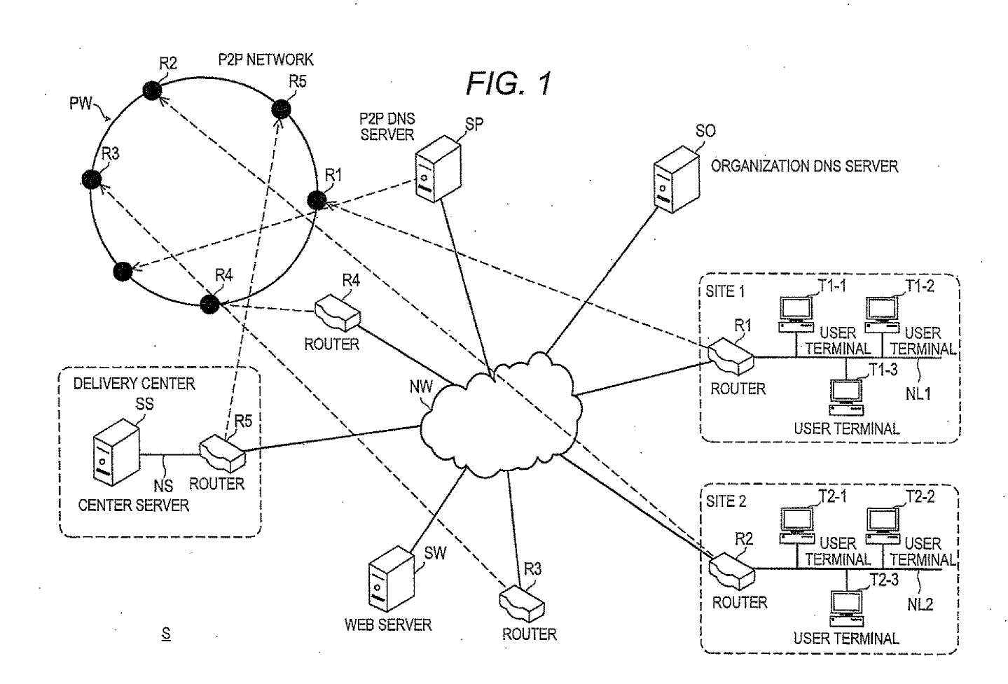

First, a description will be given of an outline configuration of a content delivery system according to this embodiment with reference to FIG. 1. The content delivery system S is a CDN applying the DNS. As illustrated in FIG. 1, in the content delivery system S, a delivery center network NS and a plurality of site networks NLm (m is any one of 1, 2, 3, . . . ) are connected to a network NW. The network NW, the delivery center network NS, and the respective site networks NLm are real-world communication networks.

The network NW mutually connects the delivery center network NS to the respective site networks NLm. The network NW is configured by, for example, a wide area network (WAN). The network NW is constructed by, for example, an internet exchange (IX), an internet service provider (ISP), a device of a digital subscriber line (DSL) network operator, a device of a fiber to the home (FTTH) network operator, and a communication line. The network NW may be configured by a network only for the content delivery system S.

The delivery center network NS is configured by, for example, a network constructed within a site of a delivery center. The delivery center network NS is constructed by, for example, a local area network (LAN). The delivery center network NS is connected with a center server SS. The center server SS populates a content into a P2P network PW. The “populating the content” means that the content is saved in any router Rm, and the saved content can be acquired by each router Rm.

Each site network NLm is a network constructed within an area of each site m. The site m is a site in which, for example, a company, a school, a hospital, a karaoke box, and an organization such as an institution are active. The site network NLm is constructed by, for example, a LAN. Each of the site networks NLm is connected with a plurality of user terminals Tm-n (n is any one of 1, 2, 3 . . . ). The user terminals Tm-n are configured by, for example, personal computers. In FIG. 1, parts of the site networks NLm and the user terminals Tm-n connected to the parts of the site networks NLm are omitted.

The network NW is also connected with a web server SW, an organization DNS server SO, and a P2P DNS server SP. The web server SW is a server device for delivering various contents of the web site operated by an organization having the above-mentioned site m to the user terminals Tm-n. In FIG. 1, only one web server SW is illustrated. However, the web server SW is installed, for example, in each organization. Domain names are allocated to the respective web servers SW.

The organization DNS server SO is a DNS server for resolving the domain name. The organization DNS server SO accepts an inquiry of an IP address from the user terminal Tm-n. In FIG. 1, only one organization DNS server SO is illustrated. The organization DNS server SO may be installed, for example, in each organization.

The content saving permission message is also a DNS server for resolving the domain name. The P2P DNS server SP accepts an inquiry of the IP address from the organization DNS server SO. A unique domain name is allocated to the P2P DNS server SP.

The delivery center network NS and the site networks NLm are steadily connected with the respective routers Rm. The respective routers Rm connect the delivery center network NS and the site networks NLm to the network NW. The router Rm is configured by, for example, a firewall having a router function or a broadband router.

In the content delivery system S, the P2P network PW that is a peer-to-peer network for delivering the content is constructed. As illustrated in FIG. 1, the P2P network PW is a logical overlay network constructed on the network NW. The P2P network PW is a network into which the plurality of routers Rm and the P2P DNS server SP, which configure the content delivery system S, enter. In the following description, the routers Rm and the P2P DNS server SP, which are connected to the P2P network PW, are each called “node”. Entering into the P2P network PW allows a state in which one node can transmit and receive various messages with respect to other nodes on the basis of a distributed hash table (DHT) routing table that will be described later.

The P2P network PW is realized by a specific algorithm, for example, an algorithm using the DHT. A node ID that is unique identification information represented by a given number of digits is allocated to each node connected to the P2P network PW. The P2P network PW illustrated in FIG. 1 has a ring-shaped ID space of the node IDs. The positions of the respective nodes illustrated in the ring-shaped IP space of FIG. 1 correspond to the respective node IDs.

Each of the nodes holds a routing table using the DHT. The routing table is called “DHT routing table”. The DHT routing table specifies the transfer destinations of the various messages on the P2P network PW. More specifically, plural pieces of node information including the node IDs, the IP addresses, and the port Nos. of the nodes that are appropriately apart from each other within the ID space is registered in the DHT routing table. The DHT routing using the DHT routing table has been known by JP-A-2006-197400 which is incorporated herein by reference, and therefore its detailed description will be omitted.

In the P2P network PW, various contents different in substance are distributed and saved in the plurality of nodes. In the following description, the node that saves the content is called “content holding node”. A content ID that is unique identification information to each content is allocated to each content. The P2P DNS server SP may not save the content.

The contents are classified into a main content that is mainly delivered by the content delivery system S through the P2P network PW, and an auxiliary content different from the main content. In this example, the content delivered through the P2P network PW means the content transmitted and received between the nodes that enter into the P2P network PW. For example, if the site Pn is a karaoke bar, karaoke data exemplifies the main content. On the other hand, the auxiliary content is exemplified by the same content as the content delivered from the web server SW. For example, a manager of the web server SW registers the content to be delivered in the web server SW, and requests the manager of the P2P network PW to populate the content into the P2P network PW. The manager of the P2P network PW operates the center server SS to populate the requested content into the P2P network PW from the center server SS. When the DNS server normally used is set as the organization DNS server SO, the user terminal Tm-n acquires the content from not the web server SW but the P2P network PW. If the Karaoke data is delivered as the main content, the content in this embodiment may be dealt with as the auxiliary content.

There is a case in which a combined content made up of a plurality of contents is populated as the auxiliary content. The combined content is, for example, a web page or a rich internet application (RIA). The contents configuring the combined content are called “normal content”. For example, the web page is configured by the normal content such as a hypertext markup language (HTML) document, image data, moving image data, audio data, or text data. The content ID of the normal content is generated by, for example, hashing the uniform resource locator (URL) of the normal content through a common hash function. The content ID of each file configuring the combined content is described in, for example, a metafile of the combined content. The metafile of the combined content is a file for retrieving and acquiring the respective normal contents configuring the combined content through the P2P network. A content ID of the combine content is allocated to the metafile of the combined content. The metafile of the combined content to which the content ID is allocated is populated into the P2P network PW as one content.

Each of the combined content and the normal content is associated with the domain of the web server SW that is an original delivery source of the normal content. The user terminals Tm-n acquires the IP address of the router Rm that acquires the content from the P2P network PW on the basis of the domain name of the web server SW which is an original acquisition destination of the content. The router Mm side does not know which of the same contents as those delivered from the web server SW is really requested from the user terminals Tm-n. Under the circumstances, each of the routers Rm normally saves the contents by the domain so as to meet the request for any content.

For the purpose of saving the contents by the domain, the domain IDs are allocated to the domains of the respective web servers SW. The domain ID is generated by, for example, hashing the domain name through the same hash function as that at the time of generating the content ID. When all of the contents delivered from the web server SW of the domain corresponding to the domain ID is regarded as one content, the domain ID can be regarded as the content ID of the one content. Each node uses the domain ID as the content ID, thereby making it possible to retrieve the content holding node that saves the same content as the content delivered from the web server SW of the domain corresponding to the domain ID. The same content as the content delivered from the web server SW of a certain domain is called “content corresponding to the domain”.

A location of the content distributed and saved in the plurality of nodes is stored in the node that manages (stores) the location of the content as index information. The node that manages the location of the content is called “root node”. The index information includes a set of the node information on the node that saves the content and the content ID of the content. This root node is determined as a node having the node ID closest to the content ID. The node ID closest to the content ID is, for example, the node ID in which the most higher-order digits of the ID match each other.

When a certain node is going to acquire some content, the node transmits a retrieval message. In the following description, the node that is going to acquire the content is called “user node”. The retrieval message includes the content ID of the content to be acquired and the IP address of the user node. The retrieval message is a message for retrieving the content holding node. The user node transmits the retrieval message to another node according to a DHT routing table stored in the user node. As a result, the retrieval message finally arrives at the root node through the DHT routing with the content ID as a key.

The root node that has received the retrieval message transmits the index information corresponding to the content ID included in the retrieval message to the user node. The user node transmits a content request message including the content ID to any content holding node on the basis of the IP address and the port No. included in the received index information. The content holding node uploads (transmits) the content corresponding to the content ID included in the received content request message to the user node. In this way, the user node can download (acquire) the content.

When the user node acquires and saves the content from the content holding node, the user node transmits a publish message. The publish message is a message for notifying the root node that the content is saved. The publish message includes the content ID of the content and the node information on the node device that saves the content. Like the retrieval message, the publish message arrives at the root node through the DHT routing with the content ID as a key. The root node stores the index information including the set of the node information and the content ID included in the received publish message in an index cache space. In this way, the user node newly serves as the content holding node that holds the above content.

### 2. Delivery of the Content to the User Terminals

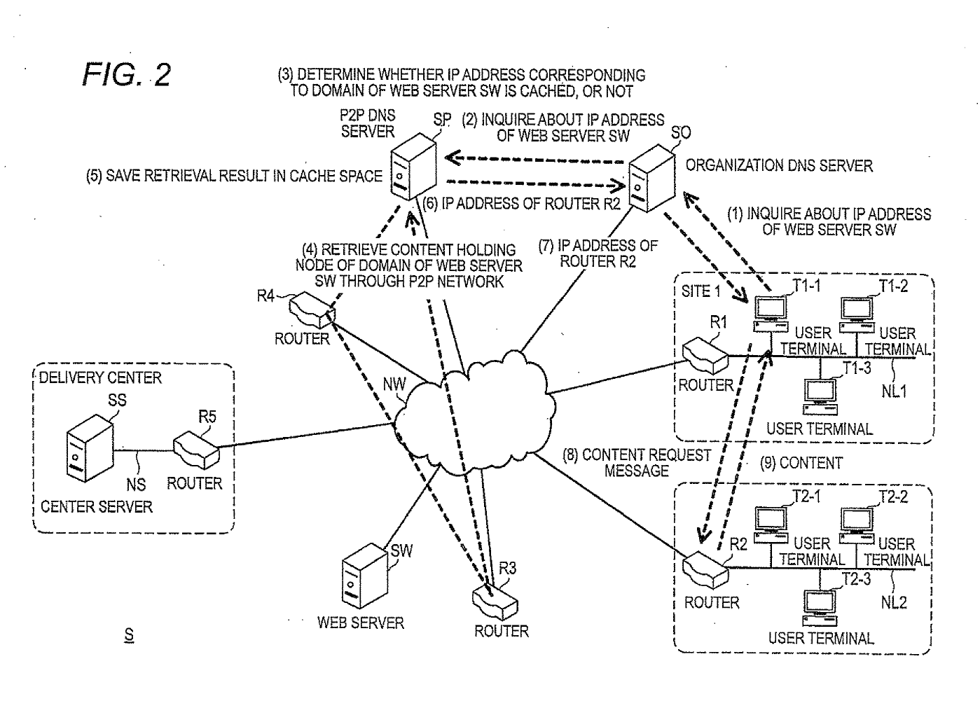

Subsequently, a description will be given of the delivery of the content to the user terminals Tm-n in the content delivery system S with reference to FIG. 2. In the content delivery system S, with the use of the P2P network PW, the delivery load of the content to the user terminals Tm-n is distributed.

The user terminal Tm-n acquires the URL of the content to be downloaded on the basis of user's operation. The user terminal Tm-n that has acquired the URL first inquires about the IP address. For example, as illustrated in FIG. 2, it is assumed that the user terminal T1-l acquires the domain name of the web server SW from the URL. The user terminal T1-l transmits a name resolution request including the acquired domain name to the organization DNS server SO ((1) of FIG. 2). The domain name included in the name resolution request is called “request domain name”.

The organization DNS server SO holds the database in which the domain names and the IP addresses are registered in association with each other. As usual, the organization DNS server SO transmits the IP address corresponding to the request domain name included in the received name resolution request to the user terminals Tm-n. However, the domain name of the web server SW is registered as an alias name in the database of the organization DNS server SO. More specifically, the domain name of the P2P DNS server is registered in association with the domain name of the web server SW. This is registration for acquiring the content from the P2P network PW to the user terminals Tm-n. Accordingly, the organization DNS server SO acquires the domain name of the P2P DNS server from the database. Further, the organization DNS server SO acquires the IP address corresponding to the domain name of the P2P DNS server from the database. Then, the organization DNS server SO transfers the received name resolution request to the P2P DNS server SP on the basis of the acquired IP address ((2) of FIG. 2).

Upon receiving the name resolution request, the P2P DNS server SP retrieves the content holding node corresponding to the requested domain name included in the name resolution request. If the P2P DNS server SP has previously retrieved the same domain name, the previous retrieval result can be used. Therefore, the P2P DNS server SP determines whether the index information corresponding to the domain ID of the requested domain name is stored in the index cache space as the retrieval result, or not ((3) of FIG. 2). The index cache space provided in the P2P DNS server SP is particularly called “retrieval result cache space”. In this example, the P2P DNS server SP generates the domain ID on the basis of the requested domain name. For example, as information indicative of the domain names and the domain IDs associated with each other, a domain list is stored in the P2P DNS server SP. Therefore, the P2P DNS server SP generates the domain ID on the basis of the domain list. Alternatively, the P2P DNS server SP may calculate the hash value of the requested domain name to generate the domain ID.

If the P2P DNS server SP determines that the index information corresponding to the requested domain name is not stored in the retrieval result cache space, the P2P DNS server SP retrieves the content holding node corresponding to the requested domain name through the P2P network PW. More specifically, the P2P DNS server SP transmits the retrieval message including the generated domain ID to acquire the index information from the router Rm as the root node ((4) of FIG. 2). Then, the P2P DNS server SP stores the index information in the retrieval result cache space ((5) of FIG. 2).

The P2P DNS server SP selects any content holding node on the basis of the index information stored in the retrieval result cache space. Then, the P2P DNS server SP returns the IP address of the selected content holding node to the organization DNS server SO ((6) of FIG. 2). In this situation, the P2P DNS server SP selects the content holding node on the basis of the number of times by which the IP addresses has been returned to the organization DNS server SO up to now, for each router Rm. The number of times is called “the number of replies”. More specifically, the P2P DNS server SP selects the content holding node smallest in the number of replies, for example, a router R2. This is because a load of the content request from the user terminals Tm-n is prevented from being concentrated on a specific router Rm.

Subsequently, when the P2P DNS server SP receives the name resolution request including the domain name of the web server SW, the P2P DNS server SP returns the IP address on the basis of the index information already stored in the retrieval result cache space. As a result, a response time to the name resolution request can be reduced. However, if a long time is elapsed since the index information is stored in the retrieval result cache space, the index information becomes old, and a difference occurs between the content holding node indicated by the index information and the real content holding node. Under the circumstances, the P2P DNS server SP does not use the index information after a given period has been elapsed since the index information has been stored in the retrieval result cache space. More specifically, when the P2P DNS server SP receives the name resolution request including the requested domain name corresponding to the index information which has been stored for the given period, the P2P DNS server SP again retrieves the content holding node corresponding to the requested domain name. For that reason, the P2P DNS server SP deletes the index information that has been stored in the retrieval result cache space for the given period from the retrieval result cache space.

The P2P DNS server SP may not delete the index information that has been stored in the retrieval result cache space for the given period from the retrieval result cache space. For example, the P2P DNS server SP may not use the index information that has been stored for the given period, for a given period. That is, the P2P DNS server SP may not transmit the IP address included in the index information that has been stored for the given period to the organization DNS server SO for the given period. Then, the P2P DNS server SP may again use the index information determined to be not used, after the given period has been elapsed. As a result, the IP address of the same router Rm is prevented from being always transmitted. In this case, the P2P DNS server SP sets information indicative of no use and information indicative of a no-use period, for example, in association with the index information. The P2P DNS server SP may transmit, to the organization DNS server, the IP address included in the index information except for the index information set to be not used among the index information corresponding to the requested domain name included in the received name resolution request. The P2P DNS server SP may again retrieve the content holding node corresponding to the requested domain name if all of the index information corresponding to the requested domain name is the index information set to be not used. Then, the P2P DNS server SP may store the index information acquired by retrieval in the retrieval result cache space, and transmit the IP address included in the index information to the organization DNS server.

The organization DNS server SO that has received the IP address of the router R2 transfers the IP address to the user terminal T1-l ((7) of FIG. 2). Then, the user terminal T1-l transmits a content request message that is the HTTP (hypertext transfer protocol) request to the router R2 as the content on the basis of the received IP address ((8) of FIG. 2). The router R2 transmits the content corresponding to the received content request message to the user terminal T1-l ((9) of FIG. 2).

### 3. Addition of the Content Holding Node

Subsequently, a description will be given of the addition of the content holding node in the content delivery system S.

As described above, the P2P DNS server SP returns the IP address of the router Rm that saves the content to be acquired by the user terminals Tm-n. For that reason, when the router Rm receives the request for the content from the user terminals Tm-n, the router Rm has no need to retrieve the router Rm that saves the requested content to acquire the content from another router Rm. However, if the number of routers Rm that save the content corresponding to a specific domain is small, the requests from the user terminals Tm-n are concentrated on the specific router Rm. Under the circumstances, the P2P DNS server SP adds the content holding node in cooperation with the respective routers Rm. As a result, since the content holding node is increased, the load on the router Rm is distributed.

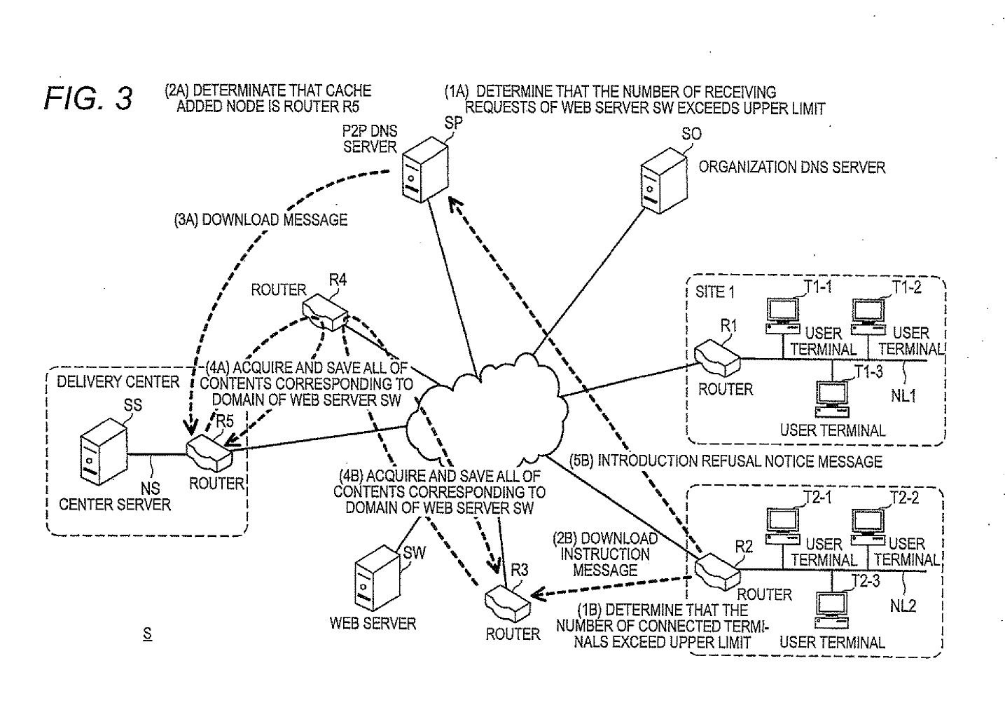

More specifically, the P2P DNS server SP counts the number of times by which the name resolution request is received, for each domain. The number of times is called “the number of receiving the request”. It is assumed that the P2P DNS server SP determines that, for example, as illustrated in FIG. 3, the number of receiving the request corresponding to the domain of the web server SW exceeds an upper limit ((1A) of FIG. 3). Then, the P2P DNS server SP adds the content holding node of the content corresponding to the domain of the web server SW. This is because when the number of receiving the request exceeds the upper limit, the requests for the content corresponding to the specific domain are concentrated, or are being concentrated. In this example, the P2P DNS server SP may determine the upper limit, for example, on the basis of the number of present content holding nodes of the content corresponding to the domain of the web server SW. The number of content holding nodes is called “the number of holders”. More specifically, as the number of holders is larger, the load of the content request is more distributed. As a result, for example, the number of holders can be gradually increased with an increase in the number of receiving the requests. Thus, a condition under which the content holding node is added can be made proper.

If the P2P DNS server SP determines that the number of receiving the requests exceeds the upper limit, the P2P DNS server SP determines a new content holding node. More specifically, the P2P DNS server SP determines, as the new content holding node, the router Rm smallest in the number of replies, for example, a router R5, among the routers Rm that do not save the content corresponding to the domain of the web server SW ((2A) of FIG. 3). Then, the P2P DNS server SP transmits, to the router R5, a download instruction message including the domain ID of the domain of the web server SW ((3A) of FIG. 3). The download instruction message is indicative of an instruction for increasing the content holding node. More specifically, the download instruction message downloads the content corresponding to the instructed domain to the router Rm that is a destination of the message.

The router R5 downloads all of the contents corresponding to the domain from the content holding node of the contents corresponding to the domain of the web server SW, for example, a router R4, and saves the downloaded contents, on the basis of the domain ID included in the received download instruction message ((4A) of FIG. 3). The router R5 may distribute and download the contents from the plurality of content holding nodes. When the router R5 downloads all of the contents, the router R5 transmits the publish message setting the domain ID included in the download instruction message. As a result, the router R5 serves as a new content holding node corresponding to the domain of the web server SW.

On the other hand, the router Rm also determines the concentration of the content requests on the router Rm per se, and adds the content holding node. For example, the router R2 adds the content holding node if the number of user terminals Tm-n that are currently being connected to the router R2 for the purpose of acquiring the content from the router R2 exceeds a predetermined upper limit. The number of user terminals is called “the number of connected terminals”. The number of connected terminals is indicative of the number of user terminals Tm-n from which the router Rm has not yet uploaded the contents in response to the content request message, among the user terminals Tm-n that have transmitted the content request message to a certain router Rm.

When the router R2 determines that the number of connected terminals exceeds the upper limit ((1B) of FIG. 3), the router R2 determines, for example, a router R3 as the new content holding node in the same manner as that in the P2P DNS server SP ((2B) of FIG. 3). Then, the router R2 transmits the download instruction message to the router R3 ((3B) of FIG. 3). The router R3 also acquires all of the contents corresponding to the domain of the web server SW as with the router R5 ((4B) of FIG. 3).

The router R2 transmits an introduction refusal notice message to the P2P DNS server SP for the purpose of eliminating the present concentration of the content requests ((5B) of FIG. 3). Then, the P2P DNS server SP excludes the router R2 from candidates of the router Rm that return the IP addresses to the organization DNS server SO. Thereafter, when the router R2 determines that the concentration of the content requests is eliminated, the router R2 transmits the introduction refusal notice message to the P2P DNS server SP. Then, the P2P DNS server SP does not exclude the router R2 from the candidates of the routers Rm that return the IP addresses.

### 4. Configuration and Function of the Respective Units

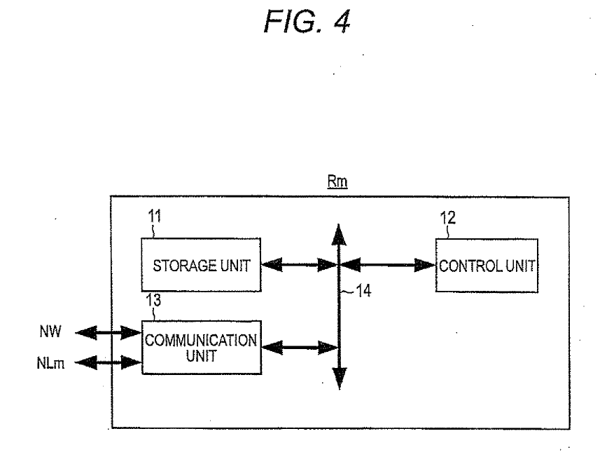

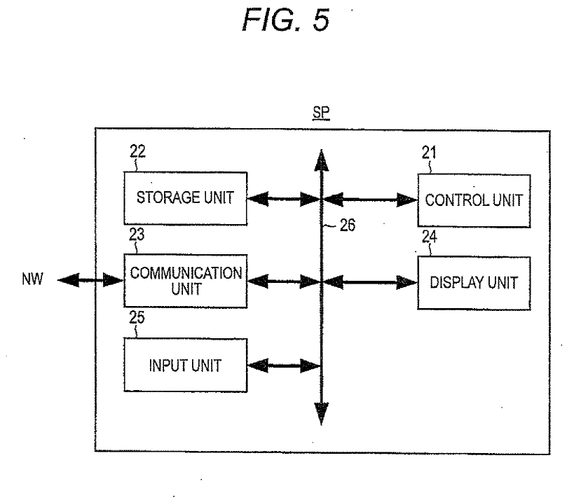

Subsequently, a description will be given of the configuration and function of the respective units with reference to FIGS. 4 and 5.

### 4.1 Configuration of the Router

As illustrated in FIG. 4, the router Rm includes a control unit 11 made up of a CPU having a computation function, an operation RAM, and a ROM that stores various data and a program therein. The router Rm includes a storage unit 12 made up of a hard disk (HD) for storing and saving various data and various programs. Further, the router Rm includes a communication unit 13 for conducting a communication control of information with another router Rm, the center server SS, the P2P DNS server SP, or the user terminal Tm-n through the network NW, the delivery center network NS, and the site networks NLm. The control unit 11, the storage unit 12, and the communication unit 13 are connected to each other through a bus 14.

The IP addresses and the port Nos. of the center server SS and the P2P DNS server SP are stored in the storage unit 12. In the storage unit 12 are stored a DHT routing table, a routing table used for routing in a network layer level, catalog information, index information, a domain list, the number of present connected terminals, the upper limit of the number of connected terminals, and a present introduction state. The introduction state is indicative of whether the router Rm refuses the IP address of the router Rm from being returned to the organization DNS server SO, or not. As the introduction state, an introduction permission state or an introduction refusal state is set.

Attribute information of the respective contents that enter into the P2P network PW is described in the catalog information. The attribute information includes, for example, the content ID, a content name, a file size, and a combined content flag. The combined content flag is information indicative of whether the content is a combined content, or not. The attribute information on the combined content includes the domain ID of the domain corresponding to the combined content. The attribute information on the normal content may include the domain ID.

In the storage unit 12 are stored the downloaded contents in association with the content IDs. A fixed cache space and a dynamic cache space are allocated to the storage unit 12 as the content cache space in which the contents are stored. A maximum storage capacity of the contents is set in each content cache space. There is a case in which the capacity of the content cache space is short when the control unit 11 is going to newly store the content in the content cache space. In this case, the control unit 11 deletes, for example, a content oldest in storage time among the contents stored in the content cache space, from the content cache space. Thus, the control unit 11 ensures a capacity for storing a new content. The fixed cache space is, for example, a space in which a main content is stored, and the dynamic cache space is, for example, a space in which an auxiliary content is stored. The main content is necessary for each router Rm to execute the processing related to the content delivery system S. It is assumed that the content cache space is one space. In this case, when the router Rm receives the download instruction message from the P2P DNS server SP or another router Rm, there is a possibility that the router Rm must delete the main content from the content cache space for storing the auxiliary content. Under the circumstances, the content cache space is divided so that the necessary content is not deleted with storage of the auxiliary content.

There is a case in which the center server SS transmits the download instruction message to the router Rm for the purpose of downloading the main content to the router Rm. In this case, the download instruction message includes the content ID of the content to be downloaded. In the fixed cache space may be stored the auxiliary content downloaded when the router Rm receives the download instruction message from the center server SS. This auxiliary content is, for example, the auxiliary content to be saved by all of the routers Rm. The auxiliary content to be saved by all of the routers Rm is, for example, a content on which the requests from the user terminals Tm-n are predicted to be concentrated, such as a new content.

Further, in the storage unit 12 is stored a P2P program for transmitting and receiving various messages with respect to another node on the basis of the DHT routing table. The P2P program may be, for example, downloaded from a given server device. The P2P program may be recorded in a recording medium such as a digital versatile disc (DVD), and read from the recording medium through a drive.

The control unit 11 allows the CPU to read and execute the program stored in the storage unit 12, to thereby integrally control the respective units of the router Rm.

### 4.2 Configuration of the P2P DNS Server

As illustrated in FIG. 5, the P2P DNS server SP includes a control unit 21 made up of a CPU having a computation function, an operation RAM, and a ROM that stores various data and a program therein. The P2P DNS server SP includes a storage unit 22 made up of an HD for storing and saving various data and various programs. Further, the P2P DNS server SP includes a communication unit 23 for conducting a communication control of information with the router Rm or the organization DNS server SO through the network NW. Still further, the P2P DNS server SP includes a display unit 24 such as a CRT or a liquid crystal display for displaying various information. Yet still further, the P2P DNS server SP includes an input unit (for example, a keyboard, a mouse) 25 that accepts an instruction from an operator, and supplies an instruction signal responsive to the instruction to the control unit 21. The control unit 21, the storage unit 22, the communication unit 23, the display unit 24, and the input unit 25 are connected to each other through a bus 26.

A DHT routing table, catalog information, a domain list, a request reception list, and a request reply list are stored in the storage unit 12. The domain list is information indicative of the domain names and the domain IDs associated with each other. The request reception list is information indicative of the domain name, the number of receiving the requests, and the number of holders associated with each other. The request reply list is information indicative of the IP addresses of the routers Rm, the number of replies, and the introduction states associated with each other. A retrieval result storage time is stored in the storage unit 22. The retrieval result storage time is representative of a longest time for which the index information can be stored in the retrieval result cache space.

Further, in the storage unit 22 are stored a DNS server program and the P2P program for executing the processing as the DNS server. The DNS server program and the P2P program may be, for example, downloaded from a given server on the network NW. The DNS server program and the P2P program may be, for example, recorded on a recording medium such as the DVD (digital versatile disc), and read through a drive such as the recording medium.

The control unit 21 allows the CPU to read and execute the DNS server program and the P2P program which are stored in the storage unit 22, to thereby function as a retrieval unit, a transmission unit, a determination unit, a generation unit, a second determination unit, a deletion unit, a third determination unit, a second transmission unit, a second acquisition unit, and a determination unit.

### 5. Operation of the Content Delivery System

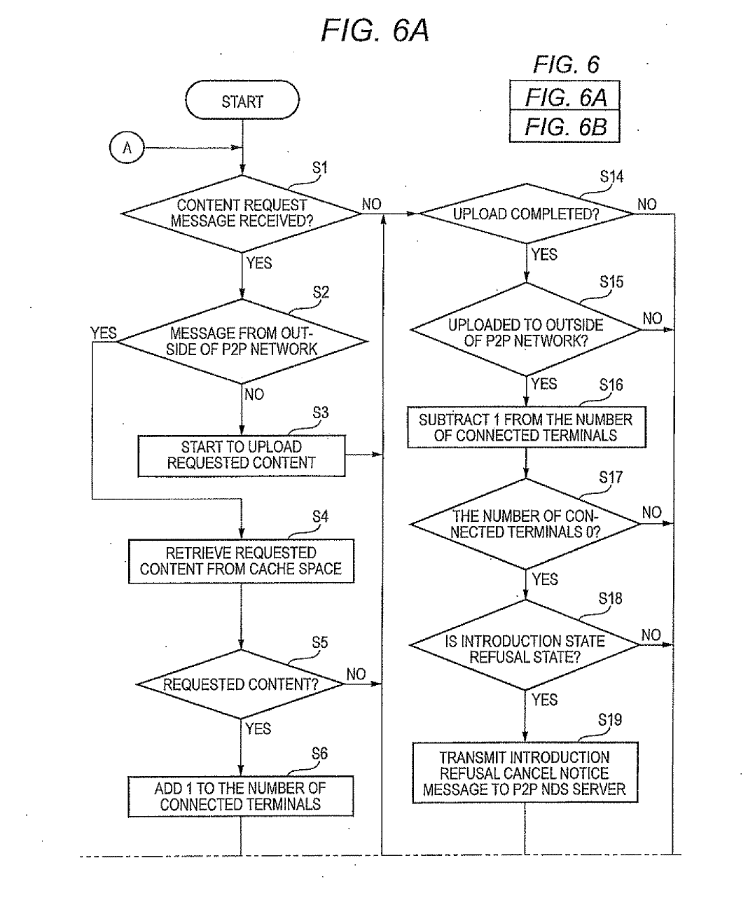

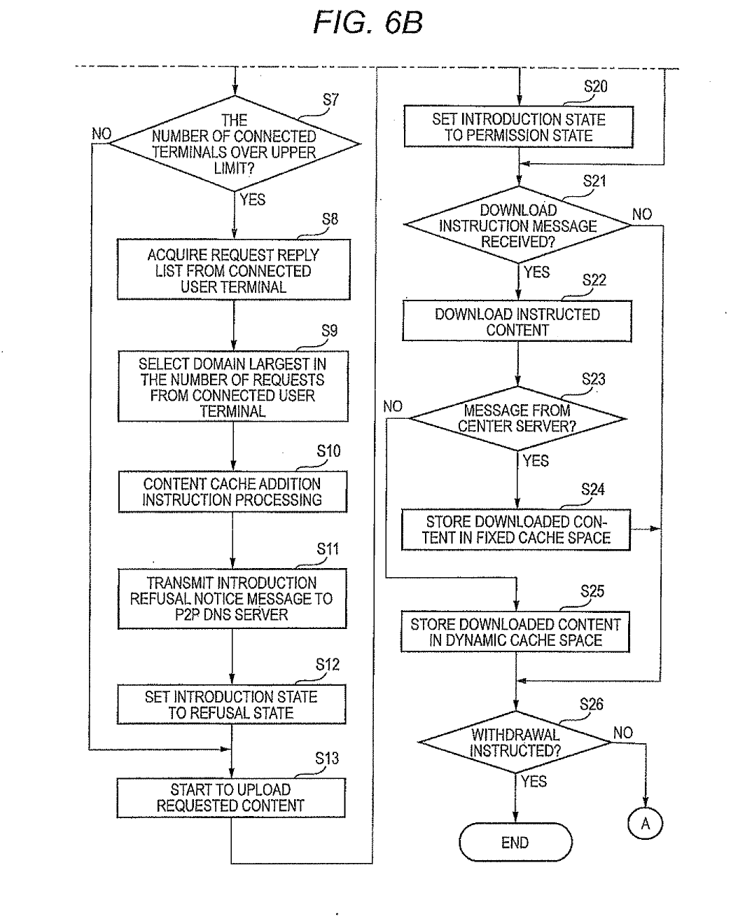

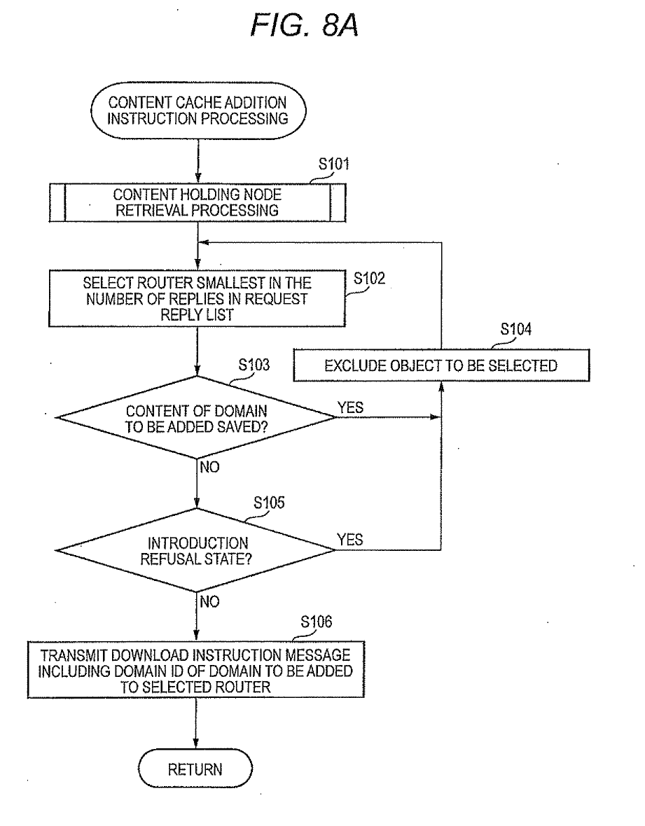

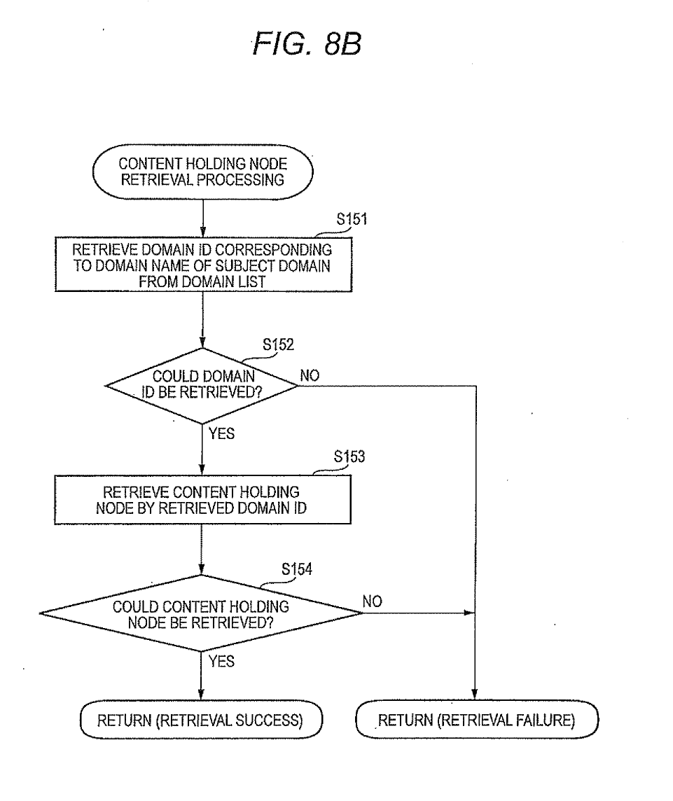

Subsequently, a description will be given of the operation of the content delivery system S according to this embodiment with reference to FIGS. 6 to 8.

The processing illustrated in FIG. 6 starts, for example, when the P2P program of the router Rm runs. First, as part of initialization, the control unit 11 sets the number of connected terminals to 0, and sets the introduction state to the introduction permission state. Then, the control unit 11 determines whether the content request message has been received, or not (Step S1). In this situation, if the control unit 11 determines that the content request message has not been received (no in Step S1), the processing is shifted to Step S14.

On the other hand, if the control unit 11 determines that the content request message has not been received (no in Step S1), the control unit 11 determines whether the content request message from the outside of the P2P network has been received, or not (Step S2). The content request message from the outside of the P2P network is the HTTP request transmitted from the user terminals Tm-n. On the other hand, the content request message from the inside of the P2P network is a message of a peer-to-peer protocol, which is transmitted from another router Rm. Accordingly, because those content request messages are different in the protocol from each other, the control unit 11 can determine where the content request message comes from, according to the port No. when the control unit 11 receives the content request message. If the control unit 11 determines that the content request message comes from the inside of the P2P network (no in Step S2), the control unit 11 starts to upload the content to the router Rm which is a source of the content request message (Step S3). Then, the control unit 11 shifts the processing to Step S14.

On the other hand, if the control unit 11 determines that the content request message comes from the outside of the P2P network (yes in Step S2), the control unit 11 retrieves the requested content from the content cache space. The content request message from the outside of the P2P network includes the URL of the requested content. Under the circumstances, the control unit 11 retrieves the content corresponding to the generated content ID from the fixed cache space and the dynamic cache space.

Subsequently, the control unit 11 determines whether the requested content is stored in the content cache space, or not, as a result of the retrieval (Step S5). In this situation, if the control unit 11 determines that the requested content is not stored therein (no in Step S5), the control unit 11 transmits an error message to the user terminal Tm-n that is a source of the content request message, and shifts the processing to Step S14.

On the other hand, if the control unit 11 determines that the requested content is stored therein (yes in Step S5), the control unit 11 adds 1 to the number of connected terminals (Step S6). Then, the control unit 11 determines whether the number of connected terminals exceeds the upper limit, or not (Step S7). In this situation, if the control unit 11 determines that the number of connected terminals does not exceed the upper limit (no in Step S7), the control unit 11 starts to upload the content (Step S13). More specifically, the control unit 11 acquires the content corresponding to the generated content ID from the content cache space. Then, the control unit 11 starts to upload the content to the user terminal Tm-n that is a source of the content request message. Then, the control unit 11 shifts the processing to Step S14.

On the other hand, if the control unit 11 determines that the number of connected terminals exceeds the upper limit (yes in Step S7), the control unit 11 acquires the request reply list from the P2P DNS server SP (Step S8). More specifically, the control unit 11 returns a request reply list request message to the P2P DNS server SP. Then, the control unit 11 receives the request reply list transmitted from the P2P DNS server SP.

Then, the control unit 11 selects a domain largest in the number of requests for the contents from the respective user terminals Tm-n which are currently being connected to the router Rm per se (Step S9). More specifically, the control unit 11 acquires the domain name from the content request message received from the respective user terminals Tm-n that are currently being connected. Then, the control unit 11 counts the number of domain names acquired from the content request message for each of the domain names. Then, the control unit 11 selects the domain name largest in the number. Then, the control unit 11 executes content cache addition instruction processing that will be described later (Step S10). In this situation, the control unit 11 delivers the selected domain name as an argument.

Then, the control unit 11 transmits the introduction refusal notice message to the P2P DNS server SP (Step S11). Then, the control unit 11 sets the introduction state to the introduction refusal state (Step S12). Then, the control unit 11 starts to upload the content to the user terminal Tm-n (Step S13), and shifts the processing to Step S14.

In Step S14, the control unit 11 determines whether there is the uploaded content among the contents that have started to be uploaded, or not. In this situation, if the control unit 11 determines that there is no content that has been uploaded (no in Step S14), the processing is shifted to step S21. On the other hand, if the control unit 11 determines that there is the content that has been uploaded (yes in Step S14), the control unit 11 determines whether the content has been uploaded to the outside of the P2P network PW, or not (Step S15). In this situation, if the control unit 11 determines that the content has been uploaded to the inside of the P2P network PW (no in Step S15), the processing is shifted to Step S21.

On the other hand, if the control unit 11 determines that the content has been uploaded to the outside of the P2P network PW (yes in Step S15), the control unit 11 subtracts 1 from the number of connected terminals (Step S16). Then, the control unit 11 determines whether the number of connecter terminals is 0, or not (Step S17). In this situation, if the control unit 11 determines that the number of connecter terminals is not 0 (no in Step S17), the processing is shifted to Step S21. On the other hand, if the control unit 11 determines that the number of connecter terminals is 0 (yes in Step S17), the control unit 11 determines whether the introduction state is the introduction refusal state, or not (Step S18). In this situation, if the control unit 11 determines that the introduction state is the introduction permission state (no in Step S18), the processing is shifted to Step S21.

On the other hand, if the control unit 11 determines that the introduction state is the introduction refusal state (yes in Step S18), the control unit 11 transmits an introduction refusal cancel notice message to the P2P DNS server SP (Step S19). Then, the control unit 11 sets the introduction state to the introduction permission state (Step S20), and shifts the processing to Step S21.

In Step S21, the control unit 11 determines whether the download instruction message has been received, or not. In this situation, if the control unit 11 determines that the download instruction message has been received (yes in Step S21), the control unit 11 downloads the instructed content (Step S22). More specifically, if the control unit 11 receives the download instruction message from the center server SS, the control unit 11 acquires the content ID from the download instruction message. Then, the control unit 11 transmits the retrieval message including the content ID to retrieve the content holding node. Then, the control unit 11 transmits the content request message to the content holding node, and downloads the content.

On the other hand, if the control unit 11 receives the download instruction message from the P2P DNS server SP or another router Rm, the control unit 11 acquires the domain ID from the download instruction message. Then, the control unit 11 retrieves the combined content corresponding to the domain ID from the catalog information. Then, the control unit 11 acquires the metafile of the combined content from another router Rm on the basis of the content ID of the retrieved combined content. A method of acquiring the metafile is identical with that of the content. Then, the control unit 11 acquires the contents ID of the respective normal contents configuring the combine content from the acquired metafile. Then, the control unit 11 acquires the normal contents from other routers Rm on the basis of the acquired contents ID. The control unit 11 executes this processing on all of the combined contents corresponding to the domain ID. Then, when the control unit 11 acquires all of the contents corresponding to the domain ID, the control unit 11 transmits the publish message including the domain ID.

When the content has been downloaded, the control unit 11 determines whether the received download instruction message is a message from the center server SS, or not (Step S23). In this situation, if the control unit 11 determines that the received download instruction message is the message from the center server SS (yes in Step S23), the control unit 11 stores the downloaded content in the fixed cache space (Step S24). On the other hand, if the control unit 11 determines that the received download instruction message is not the message from the center server SS (no in Step S23), the control unit 11 stores the downloaded content in the dynamic cache space (Step S25).

When the control unit 11 has completed the processing of Step S24 or S25, the control unit 11 determines whether a withdrawal instruction from the P2P network NW has been issued from the manager, or not (Step S26). In this situation, if the control unit 11 determines that no withdrawal instruction has been issued (no in Step S26), the processing is shifted to Step S1. On the other hand, if the control unit 11 determines that the withdrawal instruction has been issued (yes in Step S26), the control unit 11 completes the processing illustrated in FIG. 6.

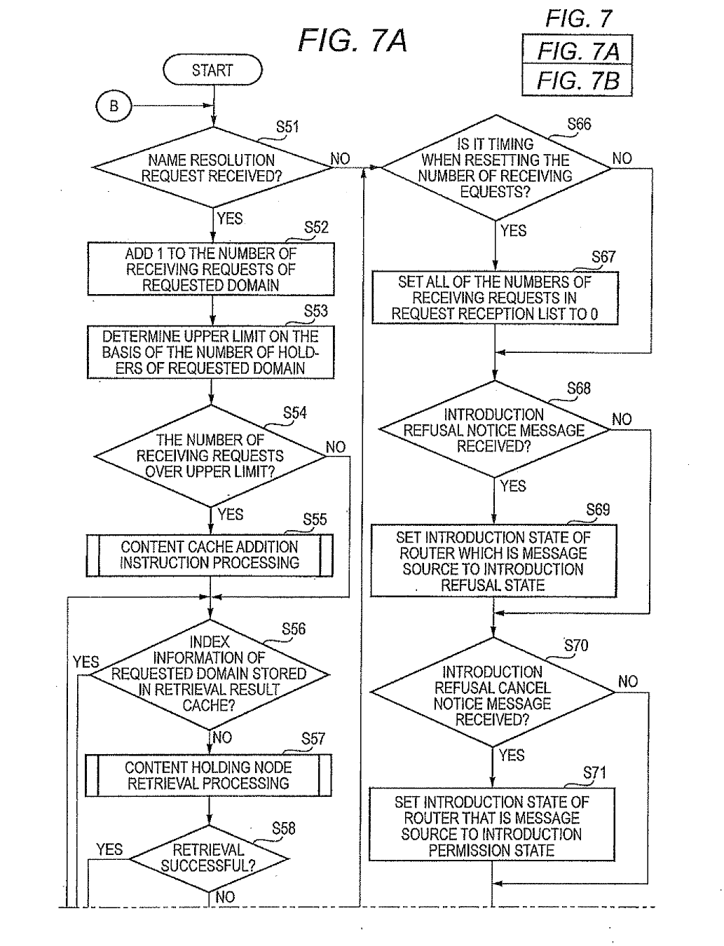

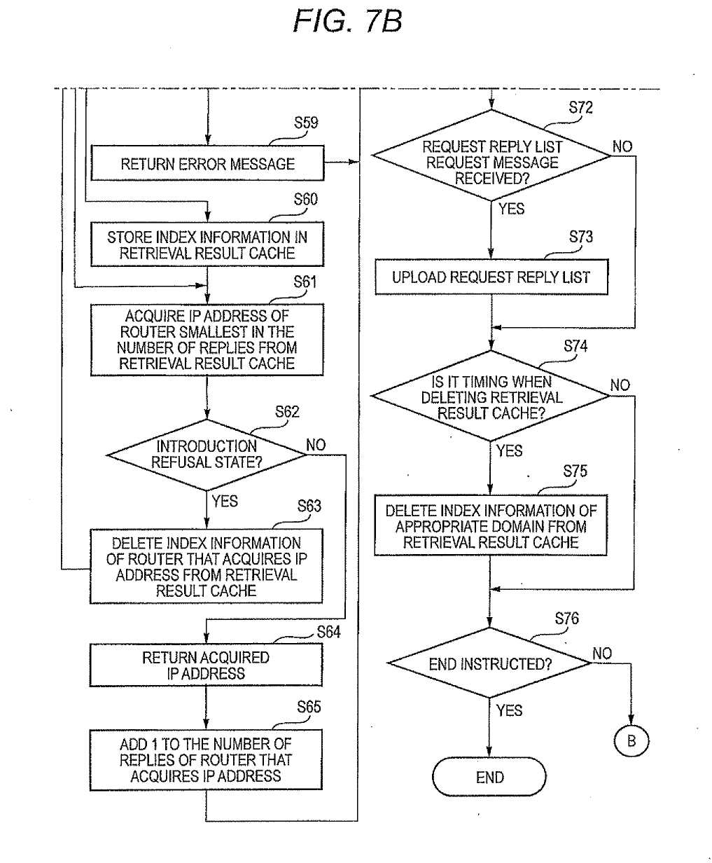

The processing illustrated in FIG. 7 starts, for example, when a power supply of the P2P DNS server SP turns on. First, as part of initialization, the control unit 21 sets all of the numbers of receiving the requests in the request reception list and the number of holders to 0. The control unit 21 sets all of the number of replies in the request reply list to 0, and sets all of the introduction states to the introduction permission state. Then, the control unit 21 determines whether the name resolution request has been received from the organization DNS server SO, or not (Step S51). In this situation, if the control unit 21 determines that the name resolution request has not been received (no in Step S51), the processing is shifted to Step S66.

On the other hand, if the control unit 21 determines that the name resolution request has been received (yes in Step S51), the control unit 21 adds 1 to the number of receiving the requests corresponding to the requested domain name included in the name resolution request (Step S52). Then, the control unit 21 determines an upper limit of the number of receiving the requests (Step S53). More specifically, the control unit 21 acquires the number of holders corresponding to the requested domain name from the request reception list. Then, the control unit 21 increases the upper limit more as the acquired number of holders is larger. In this situation, for example, the control unit 21 may apply the number of holders to a given calculating formula to calculate the upper limit. For example, the control unit 21 may determine the upper limit on the basis of table information indicative of the number of holders and the upper limit associated with each other.

Then, the control unit 21 determines whether the number of receiving the requests corresponding to the requested domain name exceeds the determined upper limit, or not (Step S54). In this situation, if the control unit 21 that the number of receiving the requests exceeds the upper limit (yes in Step S54), the control unit 21 executes the content cache addition instruction processing that will be described later (Step S55). In this situation, the control unit 21 delivers the requested domain name as an argument.

If the control unit 21 determines that the number of receiving the requests does not exceed the upper limit (no in Step S54), or the control unit 21 has completed the processing of Step S55, the control unit 21 determines whether the index information corresponding to the requested domain name is stored in the retrieval result cache space, or not (Step S56). More specifically, the control unit 21 acquires the domain ID corresponding to the requested domain name from the domain list. Then, the control unit 21 retrieves the index information corresponding to the domain ID from the retrieval result cache space. In this situation, if the control unit 21 determines that the index information corresponding to the requested domain name is stored in the retrieval result cache space (yes in Step S56), the control unit 21 shifts the processing to Step S61.

On the other hand, if the control unit 21 determines that the index information corresponding to the requested domain name is not stored in the retrieval result cache space (no in Step S56), the control unit 21 executes a content holding node retrieval processing that will be described later (Step S57). In this situation, the control unit 21 delivers the requested domain name as an argument. In the content holding node retrieval processing, the control unit 21 retrieves the content holding node of the content corresponding to the domain of the delivered domain name.

Then, the control unit 21 determines whether retrieval in the content holding node retrieval processing has succeeded, or not (Step S58). That is, the control unit 21 determines whether the content holding node of the content corresponding to the domain indicated by the requested domain name could be retrieved, or not. In this situation, if the control unit 21 determines the retrieval has not succeeded (no in Step S58), the control unit 21 returns an error message to the organization DNS server SO (Step S59). Then, the control unit 21 shifts the processing to Step S66.

On the other hand, if the control unit 21 determines the retrieval has succeeded (yes in Step S58), the control unit 21 stores the index idol/nation acquired in the content holding node retrieval processing in the retrieval result cache space (Step S60). In this situation, the control unit 21 acquires a present date and time from a timer function of the control unit 21. Then, the control unit 21 adds a retrieval result storage time to the acquired present date and time, and calculates an expiration date and time of the index information. Then, the control unit 21 stores the calculated expiration date and time in association with the domain ID of the requested domain name in the buffer memory 22. The control unit 21 calculates the number of retrieved content holding nodes according to the acquired index information. Then, the control unit 21 sets the calculated number of content holding nodes in the request reception list as the number of holders corresponding to the requested domain name.

Then, the control unit 21 acquires the IP address of the content holding node smallest in the number of replies set in the request reply list among the retrieved content holding nodes, from the index information stored in the retrieval result cache space (Step S61). Then, the control unit 21 determines whether the introduction state of the content holding node that acquires the IP address is the introduction refusal state, or not (Step S62). In this situation, if the control unit 21 determines that the introduction state is the introduction refusal state (yes in Step S62), the control unit 21 deletes the index information of the content holding node that acquires the IP address from the retrieval result cache space (Step S63). Then, the control unit 21 shifts the processing to step S56.

On the other hand, if the control unit 21 determines that the introduction state is the introduction permission state (no in Step S62), the control unit 21 returns the acquired IP address to the organization DNS server SO (Step S64). The control unit 21 returns the IP address of the content holding node smallest in the number of replies among the content holding nodes in which the introduction state is the introduction permission state. Then, the control unit 21 adds 1 to the number of replies of the content holding node that acquires the IP address in the request reply list (Step S65). Then, the control unit 21 shifts the processing to Step S66.

In Step S66, the control unit 21 determines whether it is timing when the number of receiving the requests is reset, or not. In this situation, if the control unit 21 determines that it is timing when the number of receiving the requests is reset (yes in Step S66), the control unit 21 sets all of the numbers of receiving the requests, which are set in the request reception list, to 0 (Step S67). When the control unit 21 continues to count the number of receiving the requests for a long time, the content old in the number of receiving the requests is reflected. Under the circumstances, the control unit 21 periodically resets the number of receiving the requests.

If the control unit 21 determines that it is not timing when the number of receiving the requests is reset (no in Step S66), of if the control unit 21 has completed the processing of Step S67, the control unit 21 determines whether the introduction refusal notice message has been received from the router Rm, or not (Step S68). In this situation, if the control unit 21 determines that the introduction refusal notice message has been received (yes in Step S68), the control unit 21 sets the introduction state of the router Rm that is a source of the introduction refusal notice message to the introduction refusal state (Step S69).

If the control unit 21 determines that the introduction refusal notice message has not been received (no in Step S68), or if the control unit 21 has completed the processing of Step S69, the control unit 21 determines whether the introduction refusal cancel notice message has been received from the router Rm, or not (Step S70). In this situation, if the control unit 21 determines that the introduction refusal cancel notice message has been received (yes in Step S70), the control unit 21 sets the introduction state of the router Rm that is a source of the introduction refusal cancel notice message to the introduction permission state (Step S71).

If the control unit 21 determines that the introduction refusal cancel notice message has not been received (no in Step S70), or if the control unit 21 has completed the processing of Step S71, the control unit 21 determines whether a request reply list request message has been received from the router Rm, or not (Step S72). In this situation, if the control unit 21 determines that the request reply list request message has been received (yes in step S72), the control unit 21 uploads the request reply list to the router Rm that is a source of the request reply list request message (Step S73).

If the control unit 21 determines that the request reply list request message has not been received (no in step S72), or if the control unit 21 has completed the processing of Step S73, the control unit 21 determines whether it is timing when the index information stored in the retrieval result cache space is deleted, or not (Step S74). More specifically, the control unit 21 acquires a present date and time from a timer function of the control unit 21. Then, the control unit 21 determines whether there is a date and time older than the present date and time among the expiration date and time of the index information stored in the buffer memory 22, or not. In this situation, if the control unit 21 determines that there is the expiration date and time older than the present date and time, the control unit 21 determines that it is the timing when the index information is deleted (yes in Step S74). In this case, the control unit 21 acquires the domain ID corresponding to the expiration date and time indicative of the date and time older than the present date and time. Then, the control unit 21 deletes all of the index information corresponding to the acquired domain ID from the retrieval result cache space (Step S75).

If the control unit 21 determines that it is not the timing when the index information is deleted (no in Step S74), or if the control unit 21 has completed the processing of Step S75, the control unit 21 determines whether an end instruction has been issued from the manager, or not (Step S76). In this situation, if the control unit 21 determines that the end instruction has not been issued (no in Step S76), the control unit 21 shifts the processing to Step S51. On the other hand, if the control unit 21 determines that the end instruction has been issued (yes in Step S76), the control unit 21 completes the processing of illustrated in FIG. 7.

The content cache addition instruction processing in the router Rm is also identical with that in the P2P DNS server SP.

First, the control unit 21 executes the content holding node retrieval processing that will be described later (Step S101). In this situation, the control unit 21 delivers the domain name delivered as the argument as an argument of the content holding node retrieval processing. Then, the control unit 21 selects the router Rm smallest in the number of replies in the request reply list (Step S102). Then, the control unit 21 determines whether the selected router Rm saves the content of the domain to be added to the content cache space, or not (Step S103). More specifically, the control unit 21 determines whether there is the selected router Rm in the content holding node retrieved in the content holding node retrieval processing, or not. In this situation, if there is the selected router Rm in the retrieved content holding node, the control unit 21 determines that the content of the domain to be added is saved (yes in Step S103). In this case, the control unit 21 excludes the presently selected router Rm from objects to be subsequently selected (Step S104), and again selects the router Rm (Step S102).

On the other hand, if there is no selected router Rm in the retrieved content holding node, the control unit 21 determines that the content of the domain to be added is not saved (no in Step S103). In this case, the control unit 21 determines whether the introduction state of the selected router Rm is the introduction refusal state in the request reply list, or not (Step S105). In this situation, if the control unit 21 determines that the introduction state is the introduction refusal state (yes in Step S105), the control unit 21 shifts the processing to Step S104.

On the other hand, if the control unit 21 determines that the introduction state is the introduction permission state (no in Step S105), the control unit 21 transmits the download instruction message including the domain name of the domain to be added to the selected router Rm (Step S106). Upon completion of the processing in Step S106, the control unit 21 completes the content cache addition instruction processing.

The content holding node retrieval processing in the router Rm is also identical with that in the P2P DNS server SP.

First, the control unit 21 retrieves the domain ID corresponding to the domain name delivered as the argument, from the domain list (Step S151). Then, the control unit 21 determines whether the domain ID could be retrieved, or not (Step S152). In this situation, if the control unit 21 determines that the domain ID could be retrieved (no in Step S152), the control unit 21 completes the content holding node retrieval processing, and returns a retrieval failure as the processing result.

On the other hand, if the control unit 21 determines that the domain ID could be retrieved (yes in Step S152), the control unit 21 transmits the retrieval message including the retrieved domain ID, to thereby retrieve the content holding node (Step S153). Then, the control unit 21 determines whether the content holding node could be retrieved, or not (Step S154). In this situation, if the control unit 21 receives the index information on the content holding node from the root node according to the transmitted retrieval message, the control unit 21 determines that the content holding node could be retrieved (yes in Step S154). In this case, the control unit 21 completes the content holding node retrieval processing, and returns a retrieval success as the processing result. On the other hand, if the control unit 21 could not receive the index information of the content holding node from the root node, the control unit 21 determines that the content holding node could not be retrieved (no in Step S154). In this case, the control unit 21 completes the content holding node retrieval processing, and returns a retrieval failure as the processing result.

In the above embodiment, the P2P DNS server SP determines the upper limit of the number of receiving the requests on the basis of the number of holders. Alternatively, the upper limit may be a fixed value.

In the above embodiment, the router Rm transmits the introduction refusal notice message by the connected terminals of the same number as that of connected terminals that execute the content cache addition processing. However, if the router Rm, for example, executes the content cache addition processing, increases the content holding node, and thereafter further increases the number of connected terminals, the router Rm may transmit the introduction refusal notice message. For example, if the number of connected terminals is a given number larger than 0, or smaller, the router Rm may transmit the introduction refusal cancel notice message. The router Rm may not transmit the introduction refusal notice message and the introduction refusal cancel notice message.

Each router Rm may transmit a message indicative of a saving status of the content to the P2P DNS server SP every time the content is stored in the content cache space, or deleted therefrom. Then, the P2P DNS server SP may add or delete the index information with respect to the retrieval result cache space, or may update the number of holders in the request reception list, on the basis of the message received from the router Rm. In this case, the P2P DNS server SP may not enter into the P2P network PW. This is because the P2P DNS server SP has no need to retrieve the content holding node corresponding to the domain by itself.

In the above embodiment, the node device is applied to the router. However, the node device may be applied to a network equipment having a function of relaying information, such as a proxy server, a load balancer, or a web accelerator. The node device may be applied to a server device such as a cache server or an edge server.

The information processing device may be applied to a DNS server having both functions of the P2P DNS server SP and the organization DNS server SO in the above embodiment. In this case, an inquiry device is the user terminals Tm-n.

In the above embodiment, the peer-to-peer network using the DHT is applied to the overlay network. However, the present invention is not limited to this configuration. For example, another peer-to-peer system, or a system using an overlay network may be applied. As the peer-to-peer system using no DHT, for example, there is a hybrid peer-to-peer system.

What is claimed is:

1. An information processing device in an information communication system in which a plurality of node devices are connected to a network to configure an overlay network, and contents are distributed and saved in the plurality of node devices, the information processing device comprising:
an acquisition unit configured to acquire domain information indicative of a domain name inquired by an inquiry device;
a retrieval unit configured to retrieve the content corresponding to the indicted domain name through the overlay network;
a transmission unit configured to transmit, to the inquiry device, location information indicative of a location of the node device that saves the content corresponding to the indicated domain name;
a storage unit configured to store the location information retrieved by the retrieval unit in association with the domain information; and
a first determination unit configured to determine whether the location information corresponding to the acquired domain information is stored in the storage unit or not,
wherein if the first determination unit determines that the location information is stored in the storage unit, the transmission unit transmits, to the inquiry device, the location information stored in the storage unit and corresponding to the acquired domain information, and
wherein if the first determination unit determines that the location information is not stored in the storage unit, the retrieval unit retrieves the content.

2. The information processing device according to claim 1 further comprising a generation unit configured to generate key information on the basis of the domain information acquired by the acquisition unit, the key information indicative of a retrieval key which is used to retrieve the content corresponding to the indicated domain name through the overlay network,
wherein the retrieval unit retrieves the content corresponding to the key information through the overlay network on the basis of the key information generated by the generation unit.

3. The information processing device according to claim 1 further comprising: a second determination unit configured to determine whether a given time is elapsed since the location information is stored in the storage unit or not,
wherein the transmission unit does not transmit the location information if the second determination unit determines that the given time is elapsed.

4. The information processing device according to claim 1 further comprising:
a second storage unit configured to store frequency information indicative of a frequency at which the domain information is acquired by the acquisition unit in association with the domain information;
a third determination unit configured to determine whether the frequency indicated by the stored frequency information exceeds a given value or not; and
a second transmission unit configured to transmit, to any node device, indication information indicative of an instruction for saving the content corresponding to the domain name indicated by the domain information corresponding to the frequency information in any one of the plurality of node devices if the third determination unit determines that the frequency indicated by the stored frequency information exceeds the given value.

5. The information processing device according to claim 4 further comprising:
a second acquisition unit configured to acquire quantity information indicative of the number of the node devices that save the content for each of the domain information; and
a fourth determination unit configured to determine the given value, and determine the larger given value with the domain information larger in the number indicated by the quantity information acquired by the second acquisition unit,
wherein the third determination unit determines whether the frequency indicated by the frequency information stored in the second storage unit exceeds the given value determined by the fourth determination unit or not.

6. The information processing device according to claim 4, wherein the transmission unit transmits the indication information to any node device other than the node device which transmits an introduction refusal notice message to the information processing device.

7. An information processing method in an information communication system in which a plurality of node devices are connected to a network to configure an overlay network, and contents are distributed and saved in the plurality of node devices, the information processing method comprising:
acquiring domain information indicative of a domain name inquired by an inquiry device;
determining whether location information indicative of a location of the node device that saves the content corresponding to the indicated domain name is stored in a storage unit or not;
if it is determined that the location information is stored in the storage unit, transmitting, to the inquiry device, the location information stored in the storage unit and corresponding to the acquired domain information; and
if it is determined that the location information is not stored in the storage unit,
retrieving the content corresponding to the indicted domain name through the overlay network;
transmitting, to the inquiry device, the location information indicative of the location of the node device that saves the retrieved content; and
storing the location information indicative of the location of the node device that saves the retrieved content in association with the domain information in the storage unit.

8. The information processing method according to claim 7 further comprising:
storing frequency information indicative of a frequency at which the acquired domain information in association with the domain information;
determining whether the frequency indicated by the stored frequency information exceeds a given value or not; and
transmitting, to any node device, indication information indicative of an instruction for saving the content corresponding to the domain name indicated by the domain information corresponding to the frequency information in any one of the plurality of node devices if it is determined that the frequency indicated by the stored frequency information exceeds the given value.

9. A computer readable recording medium, the recording medium storing an information processing program executable by a computer included in an information processing device in an information communication system in which a plurality of node devices are connected to a network to configure an overlay network, and contents are distributed and saved in the plurality of node devices, the information processing program causing the computer to execute:
acquiring domain information indicative of a domain name inquired by an inquiry device;
determining whether location information indicative of a location of the node device that saves the content corresponding to the indicated domain name is stored in a storage unit or not;
if it is determined that the location information is stored in the storage unit, transmitting, to the inquiry device, the location information stored in the storage unit and corresponding to the acquired domain information; and
if it is determined that the location information is not stored in the storage unit,
retrieving the content corresponding to the indicted domain name through the overlay network;
transmitting, to the inquiry device, the location information indicative of the location of the node device that saves the retrieved content; and
storing the location information indicative of the location of the node device that saves the retrieved content in association with the domain information in the storage unit.

10. The computer readable recording medium according to claim 9, wherein the information processing program further causes the computer to execute:
storing frequency information indicative of a frequency at which the acquired domain information in association with the domain information;
determining whether the frequency indicated by the stored frequency information exceeds a given value or not; and
transmitting, to any node device, indication information indicative of an instruction for saving the content corresponding to the domain name indicated by the domain information corresponding to the frequency information in any one of the plurality of node devices if it is determined that the frequency indicated by the stored frequency information exceeds the given value.
